(19) United States
(12) Patent Application Publication
(10) Pub. No.: US 2022/0225191 A1
(43) Pub. Date: Jul. 14, 2022

(54) WIRELESS COMMUNICATION METHOD FOR MOBILITY CONTROL

(71) Applicant: ZTE CORPORATION, Shenzhen (CN)

(72) Inventors: Xiaojuan SHI, Shenzhen (CN); He HUANG, Shenzhen (CN); Mengjie ZHANG, Shenzhen (CN); Jing LIU, Shenzhen (CN)

(21) Appl. No.: 17/587,892

(22) Filed: Jan. 28, 2022

Related U.S. Application Data
(63) Continuation of application No. PCT/CN2019/098357, filed on Jul. 30, 2019.

(51) Int. Cl. H04W 36/00; H04W 36/08

(52) U.S. Cl. CPC H04W 36/00837; H04W 36/08; H04W 36/0061

(57) ABSTRACT

The present disclosure relates to method, systems and devices for use in a user equipment, includes receiving, from a source cell, at least one first message comprising configuration information and at least one execution condition of performing a handover for each of at least one target cell, receiving, from the source cell, a second message indicating one of the at least one target cell, and performing a handover to the target cell indicated by the second message based on the configuration information.

### CROSS-REFERENCE TO RELATED APPLICATION

This application claims the benefit of priority under 35 U.S.C. § 120 as a continuation of PCT Patent Application No. PCT/CN2019/098357, filed on Jul. 30, 2019, the disclosure of which is incorporated herein by reference in its entirety.

### BACKGROUND

This document is directed generally to wireless communications.

Mobility performance is one of the most important performance metrics for long term evolution (LTE) and 5th Generation (5G) new radio (NR) communication standards. In addition to traditional voice and internet data service, lots of innovative services, such as remote control, aerial, industrial automation, industrial control, Augmented Reality (AR) and Virtual Reality (VR), appear with various quality of service (QoS) requirements in recent years. Some of these innovative services may require the network with ultra-reliability and low latency. That is, the mobility performance for such services should be guaranteed with very high reliability (robust) and very low interruption time. For example, a latency target of the interruption time during handover should be as small as possible (i.e. close to Oms or Oms). Thus, the mobility performance with the interruption time approximating to Oms and high reliability is an important issue to be discussed.

### BRIEF SUMMARY

This document relates to methods, systems, and devices for mobility control of wireless communications.

The present disclosure relates to a wireless communication method for use in a user equipment. The wireless communication method comprises:

receiving, from a source cell, at least one first message comprising configuration information and at least one execution condition of performing a handover for each of at least one target cell,

receiving, from the source cell, a second message indicating one of the at least one target cell, and

performing a handover to the target cell indicated by the second message based on the configuration information.

Various embodiments may preferably implement the following features:

Preferably, the wireless communication method further comprises determining whether the at least one execution condition is met after receiving the at least one first message, to perform the handover.

Preferably, the at least one first message includes identification information of each of the at least one target cell and the second message includes the identification information of the target cell indicated by the second message.

Preferably, at least one of the configuration information, the at least one execution condition, or the identification information of different target cells is included in separate first messages.

Preferably, the at least one first message and the second message are radio resource control messages.

The present disclosure relates to a wireless communication method for use in a user equipment. The wireless communication method comprises:

performing a handover to a target cell when determining an execution condition is met,

receiving, from the target cell, a message indicating a setup procedure, and

performing the setup procedure with the target cell in response to the message.

Various embodiments may preferably implement the following features:

Preferably, the step of performing the handover to the target cell when determining the execution condition is met comprises transmitting, to the target cell, a message indicating a reconfiguration procedure of the handover is completed.

Preferably, the step of performing the handover to the target cell when determining the execution condition is met comprises transmitting, to the target cell, a message including identification information of the user equipment.

Preferably, the wireless communication method further comprises receiving, from the target cell, the execution condition.

Preferably, the message indicating the setup procedure and the message indicating a reconfiguration procedure of the handover is completed are radio resource control messages.

The present disclosure relates to a wireless communication method for use in a base station. The wireless communication method comprises:

receiving, from a user equipment, a message indicating a reconfiguration procedure of a handover to the base station is completed, and

transmitting, to the user equipment, a message indicating a setup procedure when determining that there is not any configuration information associated to the user equipment at the base station.

Various embodiments may preferably implement the following features:

Preferably, the wireless communication further comprises transmitting, to the user equipment, at least one execution condition of performing the handover.

Preferably, the message indicating the reconfiguration procedure of the handover to the base station is completed and the message indicating the setup procedure are radio resource control messages.

The present disclosure relates to a wireless communication method for use in a user equipment configured on a first cell group of a first network node of a network and a second cell group of a second network node of the network. The wireless communication method comprises:

receiving, from the network, configuration information and at least one execution condition of performing a handover for each of at least one target cell for the first cell group,

performing a cell selection procedure to select a cell after detecting a cell group failure on the first cell group, and

accessing the selected cell based on the configuration information when the selected cell is one of the at least one target cell.

Various embodiments may preferably implement the following features:

Preferably, the wireless communication method further comprises reporting, to the network, the cell group failure via the second cell group of the second network node when the selected cell is not one of the at least one target cell.

Preferably, the wireless communication method further comprises determining whether the at least one execution condition is met, for performing the handover.

Preferably, the wireless communication method further comprises receiving, from the network, an indicator for instructing the user equipment to perform the cell selection procedure.

Preferably, the cell group failure comprises at least one of a radio link failure for the first cell group, a primary cell change failure, a cell group configuration failure, or an integrity check failure indication from lower layers of the first cell group.

Preferably, the first cell group is one of a master cell group and a secondary cell group and the second cell group is another one of the master cell group and the secondary cell group.

The present disclosure relates to a wireless communication method for use in a base station. The wireless communication method comprises:

transmitting, to a user equipment configured on a first cell group of a first network node and a second cell group of a second network node, configuration information and at least one execution condition of performing a handover for each of at least one target cell for the first cell group, and

transmitting, to the user equipment, an indicator for instructing the user equipment to perform a cell selection procedure or to perform a cell group failure reporting procedure when the user equipment detects a cell group failure.

Various embodiments may preferably implement the following features:

Preferably, the cell group failure comprises at least one of a radio link failure for the first cell group, a primary cell change failure, a cell group configuration failure, or an integrity check failure indication from lower layers of the first cell group.

Preferably, the first cell group is one of a master cell group and a secondary cell group and the second cell group is another one of the master cell group and the secondary cell group.

The present disclosure relates to a wireless communication method for use in a user equipment. The wireless communication method comprises:

receiving, from a source cell, a message comprising assist information generated by a target cell,

performing a handover from the source cell to the target cell while keeping communicating with the source cell, and

stopping communicating with the source cell based on the assist information.

Various embodiments may preferably implement the following features:

Preferably, the step of stopping communicating with the source cell based on the assist information comprises stopping at least one of receiving downlink channels from or transmitting uplink channels to the source cell based on the assist information.

Preferably, the downlink channels are physical downlink shared channels and the uplink channels are physical uplink shared channels.

Preferably, the assist information indicates at least one event and the step of stopping communicating with the source cell based on the assist information comprises stopping communicating with the source cell when the at least one event occurs.

Preferably, the at least one event comprises at least one of completing accessing the target cell, receiving a downlink scheduling information from the target cell, receiving downlink data from the target cell, or receiving uplink scheduling information from the target cell.

Preferably, the assist information indicates at least one stop condition and the step of stopping communicating with the source cell based on the assist information comprises stopping communicating with the source cell when the at least one stop condition is met after accessing the target cell.

Preferably, the at least one stop condition is defined by a measurement identity identifying a measurement configuration comprising at least one measurement threshold condition.

The present disclosure relates to a wireless communication method for use in a target network node. The wireless communication method comprises:

including assist information for instructing a user equipment to stop communicating with a source network node in a message, and

transmitting the message to the user equipment via the source network node.

Various embodiments may preferably implement the following features:

Preferably, the assist information indicates at least one event and the user equipment stops communicating with the source cell when the at least one event occurs.

Preferably, the at least one event comprises at least one of completing accessing the target network node, receiving a downlink scheduling information from the target network node, receiving downlink data from the target network node, or receiving uplink scheduling information from the target network node.

Preferably, the assist information indicates at least one stop condition and the user equipment stops communicating with the source network node when the at least one stop condition is met after accessing the target network node.

Preferably, the at least one stop condition is defined by a measurement identity identifying a measurement configuration comprising at least one measurement threshold condition.

Preferably, the wireless communication method further comprises transmitting, to the source network node, an indicator indicating the assist information is transmitted to the user equipment.

Preferably, the wireless communication method further comprises receiving, from the source network node, an indicator instructing if transmitting the assist information to the user equipment is allowed.

The present disclosure relates to a wireless communication method for use in a user equipment. The wireless communication method comprises:

performing a handover from a source cell to a target cell while keeping communicating with the source cell, and

switching a packet data convergence protocol, PDCP, configuration of each of at least one data radio bearer, DRB, from a source PDCP configuration of the source cell to a target PDCP configuration of the target cell based on an operation mode of each of the at least one DRB.

Various embodiments may preferably implement the following features:

Preferably, the wireless communication method further comprises stopping communicating with the source cell when the PDCP configuration of all of the at least one DRB is switched from the source PDCP configuration to the target PDCP configuration.

Preferably, the step of stopping communicating with the source cell when the PDCP configuration of all of the at least one DRB is switched from the source PDCP configuration to the target PDCP configuration comprises stopping at least one of receiving downlink channels from or transmitting uplink channels to the source cell when the PDCP configuration of all of the at least one DRB is switched from the source PDCP configuration to the target PDCP configuration.

Preferably, the downlink channels are physical downlink shared channels and the uplink channels are physical uplink shared channels.

Preferably, the operation mode is an acknowledged mode and the step of switching the PDCP configuration of each of the at least one DRB from the source PDCP configuration of the source cell to the target PDCP configuration of the target cell based on the operation mode of each of the at least one DRB comprises switching the PDCP configuration of each of the at least one DRB from the source PDCP configuration of the source cell to the target PDCP configuration of the target cell after a PDCP status packet data unit is generated or transmitted to the target cell.

Preferably, the operation mode is an unacknowledged mode and the step of switching the PDCP configuration of each of the at least one DRB from the source PDCP configuration of the source cell to the target PDCP configuration of the target cell based on the operation mode of each of the at least one DRB comprises switching the PDCP configuration of each of the at least one DRB from the source PDCP configuration of the source cell to the target PDCP configuration of the target cell after accessing the target cell.

The present disclosure relates to a wireless communication method for use in a user equipment. The wireless communication method comprises:

performing a handover from a source cell to a target cell in response to reception of a message including time domain pattern configuration information,

acquiring a first time domain pattern and a second time domain pattern based on the time domain pattern configuration information, and

communicating with the source cell based on the first time domain pattern and with the target cell based on the second time domain pattern.

Various embodiments may preferably implement the following features:

Preferably, the time domain pattern configuration information comprises a reference uplink/downlink configuration and an offset value, and one of the first time domain pattern and the second time domain pattern is determined based on the reference uplink/downlink configuration and another one of the first time domain pattern and the second time domain pattern is determined based on the reference uplink/downlink configuration and the offset value.

Preferably, the time domain pattern configuration information comprises a first reference uplink/downlink configuration, a second reference uplink/downlink configuration, a first offset value and a second offset value, and the first time domain pattern is determined based on the first reference uplink/downlink configuration and the first offset value and the second time domain pattern is determined based on the second reference uplink/downlink configuration and the second offset value.

The present disclosure relates to a wireless communication method for use in a target network node. The wireless communication method comprises transmitting, to a user equipment, a message including time domain pattern configuration information for instructing the user equipment to perform a handover from a source network node to the target network node, for determining a first time domain pattern and a second time domain pattern by the user equipment and for communicating of the user equipment with the source network node based the first time domain pattern and with the target network node based on the second time domain pattern.

Various embodiments may preferably implement the following features:

Preferably, the time domain pattern configuration information comprises a reference uplink/downlink configuration and an offset value, and one of the first time domain pattern and the second time domain pattern is determined based on the reference uplink/downlink configuration and another one of the first time domain pattern and the second time domain pattern is determined based on the reference uplink/downlink configuration and the offset value.

Preferably, the time domain pattern configuration information comprises a first reference uplink/downlink configuration, a second reference uplink/downlink configuration, a first offset value and a second offset value, and the first time domain pattern is determined based on the first reference uplink/downlink configuration and the first offset value and the second time domain pattern is determined based on the second reference uplink/downlink configuration and the second offset value.

Preferably, the wireless communication method further comprises transmitting, to the source network node, coordination information indicating the first time domain pattern.

Preferably, the coordination information comprises time domain pattern configuration information for determining the first time domain pattern.

Preferably, the coordination information comprises a bit strings indicating radio resources in at least one uplink sub-frame configured for the source network node.

Preferably, the at least one uplink sub-frame is the uplink sub-frame transmitted from the source network node to the target network node.

Preferably, the at least one uplink sub-frame is the uplink sub-frame in the first time domain pattern.

Preferably, the at least one uplink sub-frame is determined based on the time domain pattern configuration information.

Preferably, the message is a radio resource control message.

The present disclosure relates to a network device comprising:

a communication unit configured to receive, from a source cell, at least one first message comprising configuration information and at least one execution condition of performing a handover for each of at least one target cell and a second message indicating one of the at least one target cell; and

a processor, configured to perform a handover to the target cell indicated by the second message based on the configuration information.

Various embodiments may preferably implement the following features:

Preferably, the processor and/or the network device also includes a storage unit having program code stored therein, being configured to, when being executed, cause the processor to perform any of the aforementioned method steps.

The present disclosure relates to a network device, comprising:

a communication unit configured to receive, from a target cell, a message indicating a setup procedure; and

a processor, configured to perform a handover to the target cell when determining an execution condition is met and perform the setup procedure with the target cell in response to the message.

Various embodiments may preferably implement the following features:

Preferably, the processor and/or the network device also includes a storage unit having program code stored therein, being configured to, when being executed, cause the processor to perform any of the aforementioned method steps.

The present disclosure relates to a network node, comprising:

a communication unit configured to receive, from a user equipment, a message indicating a reconfiguration procedure of a handover to the base station is completed, and transmit, to the user equipment, a message indicating a setup procedure when determining that there is not any configuration information associated to the user equipment at the base station.

Various embodiments may preferably implement the following features:

Preferably, the network node further comprises a processor being configured to perform any of aforementioned method steps.

The present disclosure relates to a network device, comprising:

a communication unit configured to receive, from the network, configuration information and at least one execution condition of performing a handover for each of at least one target cell for the first cell group; and

a processor, configured to perform a cell selection procedure to select a cell after detecting a cell group failure on the first cell group and access the selected cell based on the configuration information when the selected cell is one of the at least one target cell.

Various embodiments may preferably implement the following features:

Preferably, the processor and/or the network device also includes a storage unit having program code stored therein, being configured to, when being executed, cause the processor to perform any of the aforementioned method steps.

The present disclosure relates to a network node, comprising:

a communication unit configured to transmit, to a user equipment configured on a first cell group of a first network node and a second cell group of a second network node, configuration information and at least one execution condition of performing a handover for each of at least one target cell for the first cell group and an indicator for instructing the user equipment to perform a cell selection procedure or to perform a cell group failure reporting procedure when the user equipment detects a cell group failure.

Various embodiments may preferably implement the following features:

Preferably, the network node further comprises a processor being configured to perform any of aforementioned method steps.

The present disclosure relates to a network device comprising:

a communication unit configured to receive, from a source cell, a message comprising assist information generated by a target cell; and

a processor, configured to perform a handover from the source cell to the target cell while keeping communicating with the source cell and stop communicating with the source cell based on the assist information.

Various embodiments may preferably implement the following features:

Preferably, the processor and/or the network device also includes a storage unit having program code stored therein, being configured to, when being executed, cause the processor to perform any of the aforementioned method steps.

The present disclosure relates to a network node comprising:

a processor, configured to include assist information for instructing a user equipment to stop communicating with a source network node in a message, and

a communication unit configured to transmit the message to the user equipment via the source network node.

Various embodiments may preferably implement the following features:

Preferably, the processor and/or the network device also includes a storage unit having program code stored therein, being configured to, when being executed, cause the processor to perform any of the aforementioned method steps.

The present disclosure relates to a network device, comprising:

a processor, configured to perform a handover from a source cell to a target cell while keeping communicating with the source cell and switch a packet data convergence protocol, PDCP, configuration of each of at least one data radio bearer, DRB, from a source PDCP configuration of the source cell to a target PDCP configuration of the target cell based on an operation mode of each of the at least one DRB.

Various embodiments may preferably implement the following features:

Preferably, the processor and/or the network device also includes a storage unit having program code stored therein, being configured to, when being executed, cause the processor to perform any of the aforementioned method steps.

The present disclosure relates to a network device, comprising:

a processor, configured to perform a handover from a source cell to a target cell in response to reception of a message including time domain pattern configuration information, acquire a first time domain pattern and a second time domain pattern based on the time domain pattern configuration information, and

a communicating unit, configured to communicate with the source cell based on the first time domain pattern and with the target cell based on the second time domain pattern.

Various embodiments may preferably implement the following features:

Preferably, the processor and/or the network device also includes a storage unit having program code stored therein, being configured to, when being executed, cause the processor to perform any of the aforementioned method steps.

The present disclosure relates to a network node, comprising:

a communication unit configured to transmit, to a user equipment, a message including time domain pattern configuration information for instructing the user equipment to perform a handover from a source network node to the target network node, for determining a first time domain pattern and a second time domain pattern by the user equipment and for communicating of the user equipment with the source network node based the first time domain pattern and with the target network node based on the second time domain pattern.

Various embodiments may preferably implement the following features:

Preferably, the network node further comprises a processor being configured to perform any of aforementioned method steps.

The above and other aspects and their implementations are described in greater detail in the drawings, the descriptions, and the claims.

### BRIEF DESCRIPTION OF THE DRAWINGS

FIG. 1 shows a network device according to an embodiment of the present disclosure.

FIG. 2 shows a network node according to an embodiment of the present disclosure.

FIG. 3 shows a process according to an embodiment of the present disclosure.

FIG. 4 shows a table of conditional handover configuration according to an embodiment of the present disclosure.

FIG. 5 shows a process according to an embodiment of the present disclosure.

FIG. 6 shows a process according to an embodiment of the present disclosure.

FIG. 7 shows a scenario according to an embodiment of the present disclosure.

FIG. 8 shows a trajectory of a UE between two neighboring cells according to an embodiment of the present disclosure.

FIG. 9 shows a table of UL-DL configurations according to an embodiment of the present disclosure.

FIG. 10 shows a method of determining the time domain patterns according to an embodiment of the present disclosure.

FIG. 11 shows a method of determining the time domain patterns according to an embodiment of the present disclosure.

### DETAILED DESCRIPTION

Various exemplary embodiments of the present disclosure are described below with reference to the accompanying figures to enable a skilled person to make and use the present disclosure. As would be apparent to those of ordinary skill in the art, after reading the present disclosure, various changes or modifications to the examples described herein can be made without departing from the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

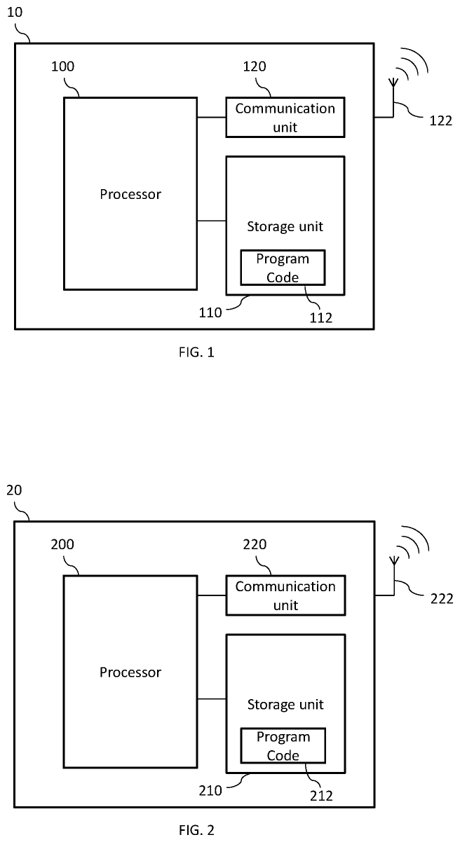

FIG. 1 relates to a schematic diagram of a network device 10 according to an embodiment of the present disclosure. The network device 10 may be a user equipment (UE), a mobile phone, a laptop, a tablet computer, an electronic book or a portable computer system and is not limited herein. The network device 10 may include a processor 100 such as a microprocessor or Application Specific Integrated Circuit (ASIC), a storage unit 110 and a communication unit 120. The storage unit 110 may be any data storage device that stores a program code 112, which is accessed and executed by the processor 100. Embodiments of the storage unit 112 include, but are not limited to, a subscriber identity module (SIM), read-only memory (ROM), flash memory, random-access memory (RAM), hard-disk, and optical data storage device. The communication unit 120 may be a transceiver and is used to transmit and receive signals (e.g. messages or packets) according to processing results of the processor 100. In an embodiment, the communication unit 120 transmits and receives the signals via an antenna 122 shown in FIG. 1.

In an embodiment, the storage unit 110 and the program code 112 may be omitted and the processor 100 may include a storage unit with stored program code.

The processor 100 may implement any one of the steps in embodiments on the network device 10.

The communication unit 120 may be a transceiver. The communication unit 120 may as an alternative or in addition be combining a transmitting unit and a receiving unit configured to transmit and to receive, respectively, signals to and from a network node (e.g. a BS).

FIG. 2 relates to a schematic diagram of a network node 20 according to an embodiment of the present disclosure. The network node 20 may be a base station (BS), a network entity, a Mobility Management Entity (MME), Serving Gateway (S-GW), Packet Data Network (PDN) Gateway (P-GW), or Radio Network Controller (RNC), and is not limited herein. The network node 20 may include a processor 200 such as a microprocessor or ASIC, a storage unit 210 and a communication unit 220. The storage unit 210 may be any data storage device that stores a program code 212, which is accessed and executed by the processor 200. Examples of the storage unit 212 include, but are not limited to, a SIM, ROM, flash memory, RAM, hard-disk, and optical data storage device. The communication unit 220 may be a transceiver and is used to transmit and receive signals (e.g. messages or packets) according to processing results of the processor 200. In an example, the communication unit 220 transmits and receives the signals via an antenna 222 shown in FIG. 2.

In an embodiment, the storage unit 210 and the program code 212 may be omitted. The processor 200 may include a storage unit with stored program code.

The processor 200 may implement any steps described in embodiments on the network node 20.

The communication unit 220 may be a transceiver. The communication unit 220 may as an alternative or in addition be combining a transmitting unit and a receiving unit configured to transmit and to receive, respectively, signals to and from a network device (e.g. a UE).

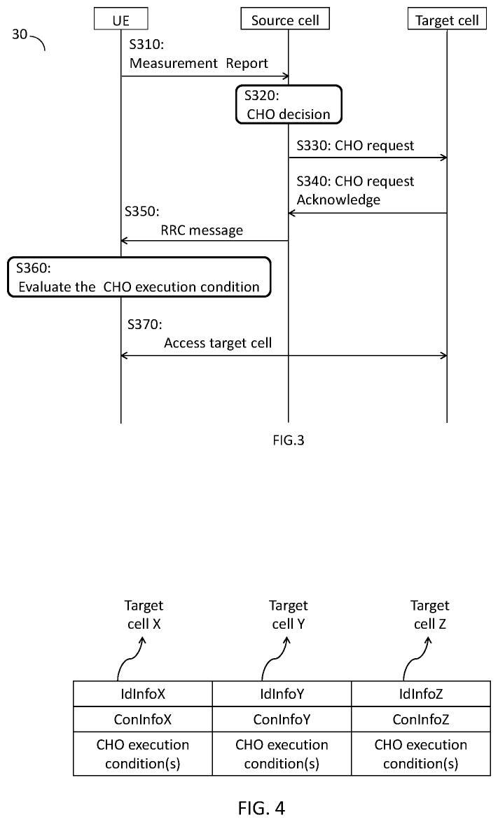

In an embodiment, a conditional handover (CHO) procedure 30 is disclosed for improving the mobility reliability of wireless communications. As its name suggests, the CHO is defined as having a configured CHO execution condition for determining when/whether a corresponding handover command is executed. Upon receiving the CHO configuration, a UE starts to evaluate the condition and only executes the handover command from a source cell to a target cell once the condition is met. FIG. 3 shows an example of a CHO procedure 30 according to an embodiment of the present disclosure. As shown in FIG. 3, the CHO procedure 30 comprises the following steps:

S310: The UE sends a measurement report to the source cell to report measurement results of the target cell.

S320: The source cell makes decision on the usage of CHO to handoff the UE based on the measurement report or radio resource management (RRM) information.

S330: The source cell sends a CHO request to the target cell.

S340: The target cell sends a CHO response, i.e. CHO request Acknowledge, to the source cell.

S350: The source cell sends a RRC message with a CHO configuration to the UE. The CHO configuration includes configuration information of the target cell and at least one corresponding CHO execution condition of the target cell.

S360: The UE maintains connection with the source cell after receiving the CHO configuration, and starts to evaluate the at least one CHO execution condition for the target cell. When the at least one CHO execution condition is fulfilled, the UE performs a handover to the target cell and applies the corresponding configuration information received in the step S350.

S370: The UE accesses the target cell.

Note that, the embodiment shown in FIG. 3 utilizes a single target cell for illustration purposes. In an embodiment, there may be a plurality of target cells in the CHO procedure. The multiple target cells can be cells in the same Radio Access Network node (RAN node), such as an evolved Node B (eNB) in LTE or a gNB in NR, or cells in different RAN nodes. In this application, cells and network nodes are used interchangeably. The CHO configuration of each target cell can be sent to the UE in the same or difference RRC messages.

In an embodiment, the CHO configuration of a target cell includes at least one of identification information identifying the target cell, configuration information of the target cell for performing the handover, or at least one CHO execution condition of the target cell.

In an example, the identification information includes at least one of an index (i.e. identity), frequency information or physical cell identity (PCI) of the target cell.

In an example, the configuration information of the target cell is generated and encapsulated into a RRC container by the target cell. For example, the RRC container in LTE may be the encoded RRCConnectionReconfiguration message. The RRC container in NR may be the encoded RRCReconfiguration message. Note that, each of the at least one CHO execution condition is defined by a measurement identity which identifies a measurement configuration.

In an example, the at least one CHO execution condition of the target cell is sent to the UE in at least one group. In S360, when all the CHO execution conditions in at least one group are fulfilled, the UE performs a handover to the target cell and applies the corresponding configuration information received in step S350.

For example, in S350, the source cell sends three CHO execution conditions for the target cell, Cond1, Cond2, Cond3 respectively. The source cell classifies the three CHO execution conditions into two groups, group1 (Cond1, Cond2) and group2 (Cond3) and sends the two groups to the UE. With the reception of the two groups, the UE evaluates the three CHO execution conditions. When Cond1 and Cond2 in group1 are fulfilled, or when Cond3 in group2 is fulfilled, the UE performs a handover to the target cell by applying of the corresponding configuration information of the target cell.

FIG. 4 shows an example of CHO configuration received by the UE according to an embodiment of the present disclosure. In the embodiment shown in FIG. 4, the CHO configuration comprises three target cells X, Y, Z and identification information, configuration information and CHO execution conditions thereof.

In an embodiment, the UE receives the CHO configuration shown in FIG. 4 from the source cell and evaluates the CHO conditions of the target cells X, Y and Z. That is, the UE performs measurements on the target cells X, Y and Z and evaluates whether the measurement results of each of the target cells X, Y and Z fulfill the corresponding CHO execution condition(s). During this period, the source cell may decide to handover the UE to the target cell Y, e.g., based on the radio resource management (RRM) strategy of the source cell. Under such a condition, the source cell may send a RRC message containing the identification information IdInfoY to the UE, to instruct the UE to perform a handover to the target cell Y. In response to the reception of the RRC message indicating the target cell Y, the UE performs a handover to the target cell Y by applying the configuration information ConInfoY of the target cell Y which was previously received and stored in the UE.

In this embodiment, because the configuration information ConInfoY of the target cell Y was received in advance by the UE for performing the CHO procedure, the source cell is able to instruct the UE to perform the handover to the target cell Y without transmitting the corresponding configuration information ConInfoY, which may comprise, e.g., physical cell identity (PCI), frequency information, cell specific parameters of the target cell Y and UE specific parameters.

That is, after receiving the CHO configuration information for performing the CHO procedure, the network (i.e. the source cell) is able to instruct the UE to perform the handover to one of the target cells without significant signal overhead. In addition, a payload size of the message instructing the handover is decreased in this embodiment. Under a condition that the communication quality between the source cell and the UE may deteriorate dramatically when the source cell determines to perform the handover, the downsized message is able to effectively reduce a failure rate of transmitting the message to the UE, so as to reduce a radio link failure rate and a handover failure rate. The radio link failure or the handover failure would cause massive data interruption. Therefore, with the reduction of the radio link failure rate and handover failure rate, the data interruption of course can be reduced.

FIG. 5 shows a process 50 according to an embodiment of the present disclosure. According to process 50, the source cell first transmits at least one first message (e.g a RRC message) to the UE, wherein the first message includes configuration information and at least one execution condition of performing a handover for each of at least one target cell (step S510). Note that, FIG. 5 shows a single target cell for simplifying the illustrations.

In addition, the configuration and the at least one execution condition of different target cells may be transmitted in different first messages.

In an embodiment, the configuration information and the execution condition may be acquired from the at least one target cell. After receiving the at least one first message, the UE evaluates the at least one execution condition of each target cell while maintaining communicating with the source cell (step S520).

During this period, the source cell transmits a second message (e.g. RRC message) indicating one of the at least one target cell, to instruct the UE to perform handover to the target cell indicated by the second message (step S530). Since the UE already has the configuration information of the indicated target cell, the source cell does not need to transmit the configuration information of the indicated target cell or other handover related information and the UE is able to perform the handover and access the indicated target cell (step S540). As a result, the signal overhead and data interruption can be effectively reduced.

In an example, the at least one first message comprises identification information of each target cell and the second message includes the identification information of the indicated target cell, to allow the UE to identify the indicated target cell.

In comparison, in the CHO process 30, the target cell may release the configuration information transmitted to the UE for performing the handover within the period of the UE evaluating the at least one CHO execution condition of the target cell or before the UE successfully accesses the target cell. For example, the target cell may decide to release the target cell (i.e. release all the CHO configuration of the target cell which has been configured for the UE) and a release message fails to reach the UE. Or, the target cell may pre-empty the UE context of the UE for allowing another high priority UE to access the target cell. Under such a condition, the UE context of UE including the configuration information configured for the UE is released on the target cell.

Under a condition that the target cell releases the configuration information transmitted to the UE, the UE determines one of the at least one CHO execution condition is fulfilled and applies the received configuration information to perform the handover to the target cell, the target cell may not respond to the UE, because the corresponded configuration information is released and the UE may start reestablishing connection with the target cell after a long idle period, resulting in a huge data interruption.

In an embodiment, the target cell may trigger a fallback procedure when determining that the configuration information, which is configured for the UE in the CHO procedure, received before performing the handover and/or applied by the UE for performing the handover to the target cell, is no longer configured for the UE (e.g. is released by the target cell).

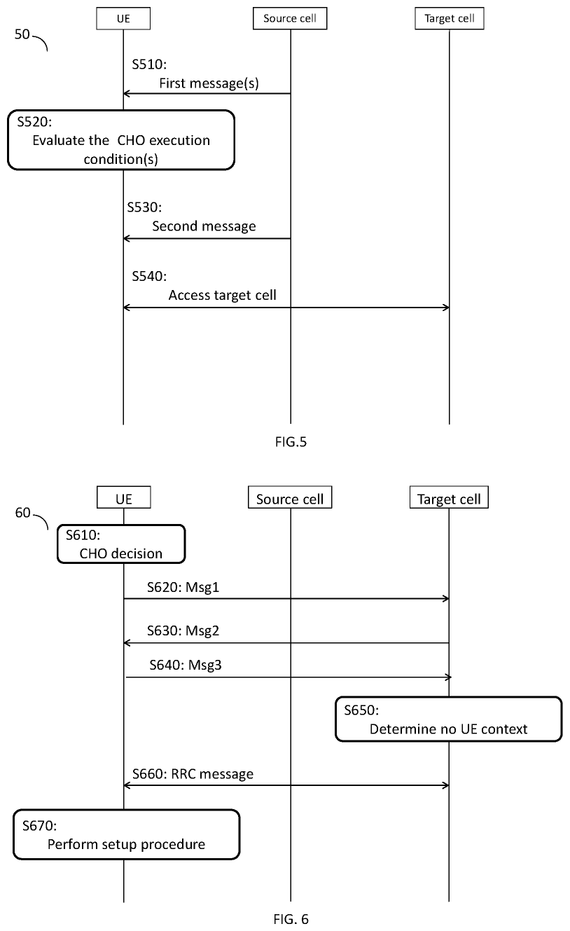

FIG. 6 shows a process 60 according to an embodiment of the present disclosure. In a step S610, the UE evaluates that measurement results of a target cell fulfill the corresponding at least one execution condition of performing a handover (e.g. a cell change and reconfigure with sync) to the target cell. In this embodiment, the UE determines the at least one execution condition is met and initiates the handover to the target cell. For example, the UE may start synchronizing to the downlink (DL) of the target cell and applies the corresponding configuration information configured by the target cell. In an example, the at least one execution condition of the target cell or the configuration information configured by the target cell are received from target cell (e.g. steps S310 to S350 shown in the CHO procedure in FIG. 3).

For performing the handover to the target cell, the UE initiates a random access procedure to the target cell and sends a random access message Msg1 to the target cell. The UE then receives a random access response Msg2 from the target cell, wherein an uplink (UL) grant for scheduling the UL physical UL shared channel (PUSCH) is included in the random access response Msg2.

Next, the UE sends a random access message Msg3 to the target cell. In an example, the random access message Msg3 includes identification information (e.g. identifier) of the UE. For example, the identification information may be a Cell Radio Network Temporary Identifier (C-RNTI). In addition, a message (e.g. RRCReconfigurationComplete) to confirm a reconfiguration procedure of the handover (e.g. indicate the reconfiguration procedure is complete) may also be included in the random access message Msg3 (steps S620 to S640).

In response to the reception of the message indicating the reconfiguration procedure of the handover is complete, the target cell determines whether there is a configuration associated to the UE or whether there is a UE context. In this embodiment, the target cell determines there is not a configuration for the UE or there is no UE context and initiates a fallback procedure (step S650).

In step S660, the target cell sends a message (e.g. a RRCConnectionSetup message) indicating a setup procedure of a RRC connection (e.g. a RRC connection establishment procedure) with the target cell. In response to the message, the UE performs the setup procedure to access the target cell (step S670).

By adopting the process 60, the UE is able to resume the RRC connection to the target cell when the received configuration information of the target cell is released by the target cell (i.e. the target cell does not find the UE context or a configuration corresponding to the UE) before the UE completes the handover to the target cell or accesses the target cell.

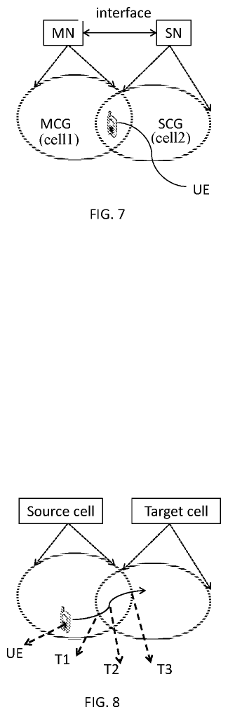

FIG. 7 shows a scenario according to an embodiment of the present disclosure. In FIG. 7, a UE is configured in the operation of dual connectivity (DC). That is, the UE connects with both a master node (MN) of a network and a secondary node (SN) of the network. The UE may be configured with at least one serving cell (e.g. cell1 shown in FIG. 7) on the MN and the at least one serving cell on the MN forms a master cell group (MCG). Similarly, the UE can be configured with at least one serving cell (e.g. cell2 shown in FIG. 7) on the SN and the at least one serving cell on the SN forms a secondary cell group (SCG).

In this embodiment, when a cell group failure takes place in the MCG, the UE performs a cell selection procedure to select a cell, e.g., select a cell as a primary cell (PCell). When the selected cell is one of the target cells configured for the MCG (i.e., for PCell change) in a CHO procedure, the UE directly applies the corresponding configuration information configured in the CHO procedure and accesses the selected target cell, i.e. change PCell to the target cell with the applying of the corresponding configuration information configured in the CHO procedure; otherwise, the UE reports the cell group failure to the MN via the SCG and the interface between the MN and the SN. In an example, the UE receives the configuration information from the network, e.g., according to the steps S310 to S350 of the CHO procedure shown in FIG. 3.

Similarly, when a cell group failure takes place in the SCG, the UE performs a cell selection procedure to select a cell, e.g., select a cell as a primary cell on the SCG (PSCell). When the selected cell is one of the target cells configured for the SCG (i.e., for PSCell change) in the CHO procedure, the UE directly applies the corresponding configuration information configured in the CHO procedure and accesses the selected target cell, i.e. change PSCell to the target cell with the applying of the corresponding configuration information configured in the CHO procedure; otherwise, the UE reports the cell group failure to the SN via the MCG and the interface between the MN and the SN.

In an embodiment, the cell group failure includes at least one of a radio link failure for the cell group (e.g. MCG or SCG), a primary cell change failure of the cell group (e.g. MCG or SCG), a cell group configuration failure, or an integrity check failure indication from lower layers of the cell group (e.g. MCG or SCG).

In order to allow the network to have more control of the UE behavior, the network (of MN or SN) may send an indicator to instruct the UE whether to perform the cell selection procedure or immediately report the cell group failure to the network when the cell group failure occurs on one of the MCG or SCG.

In this embodiment, the UE may perform the cell selection procedure first when the cell group failure occurs. Under the condition that the selected cell is one of the target cells configured for the corresponding failed cell group in the CHO procedure, the UE is able to apply the corresponding configuration information received from the network and accesses the selected target cell, i.e. change PCell or PSCell to the target cell with the applying of the corresponding configuration information configured in the CHO procedure. As a result, when the cell group failure occurs, the interruption delay and signaling overhead would be reduced. In addition, the network may send the indication to the UE for controlling the UE to immediately report CG failure information to the network or to perform the cell selection procedure first. Under such a condition, the network can have more control of the UE behavior when a cell group failure occurs.

In an embodiment, a “make-before-break” based handover procedure is disclosed to reduce mobility interruption. While performing the make-before-break based handover procedure from a source cell to a target cell, the UE keeps communicating (e.g. DL reception and/or UL transmission) with the source cell and the target cell at least for a period of time. FIG. 8 shows a trajectory of a UE between two neighboring cells (i.e. a source cell and a target cell) according to an embodiment of the present disclosure.

In FIG. 8, the UE approaches the edge of the source cell and then enters into the target cell. At a time T1, the UE receives a RRC message from the source cell for instructing the UE to perform a make-before-break based handover to the target cell. The RRC message is generated by the target cell and sent to the UE via the source cell. In addition, the RRC message may include configuration information generated by the target cell. When performing the make-before-break based handover, the UE keeps communication with the source cell while accessing the target cell based on the configuration information included in the RRC message and may also keep communicating with the source cell after successfully accesses the target cell for a period of time.

In an embodiment, the transmission between the source cell and the UE may be stopped or released at a time T3, which is the time where the network explicitly instructs the UE to stop (or release) transmission on the source cell (i.e. stop communicating with the source cell). Before the time T3, the UE performs transmission (i.e. communicates) with both the source cell and the target cell.

In an embodiment, the transmission between the source cell and the UE can be stopped or released at a time T2. The target cell may transmit assist information to the UE for assisting the determining of the time T2. The assist information is included in the RRC message for instructing the UE to perform the make-before-break based handover to the target cell. As a result, the UE can autonomously stop communicating with the source cell under the network's control and the interruption time can be reduced. The UE may stop (or release) the transmissions on the source cell or stop communicate with the source cell by stopping receiving DL channels from or transmitting UL channels to the source cell. For example, the DL channels may include physical DL shared channels (PDSCH) and the UL channels may include physical UL shared channels (PUSCH).

In an example, the assist information is included in the message of instructing the UE to perform the make-before-break based handover from the source cell to the target cell.

In an embodiment, the assist information may indicate at least one event and the time T2 is the time of the at least one event being completed or occurring. For example, the at least one event may be at least one of the UE successfully completing the random access procedure on the target cell (e.g. accessing the target cell), the UE receiving a downlink scheduling information (e.g. PDSCH assignment) from the target cell, the UE receiving a DL data (e.g. a PDSCH packet) from the target cell, the UE receiving UL scheduling information (e.g. a UL grant) from the target cell, or the UE determining a configured condition is fulfilled.

In an embodiment, the assist information may indicate at least one stop condition and the time T2 is the time at which the at least one stop condition is met. Each of the at least one stop condition can be defined by a measurement identity which identifies a measurement configuration. In an embodiment, the measurement configuration comprises at least one measurement threshold condition and the communication quality between the UE and the source cell is determined downgrade when the at least one measurement threshold condition is met. When the stop condition is fulfilled or met after the UE successfully accesses the target cell, the UE stops (or releases) the transmissions on the source cell. In an example, the measurement configuration which is identified by the measurement identity may include the threshold configuration of indicating at least one communication quality between the UE and the source cell downgrades.

In an embodiment, the target cell may transmit an indicator to the source cell, for indicating the assist information is transmitted to the UE, i.e. the assist information is included in the RRC message for instructing the UE to perform the make-before-break based handover to the target cell.

In an embodiment, the behavior of the target cell transmitting the indicator to the source cell for indicating the assist information is transmitted to the UE can be controlled by the source cell. For example, the source cell may transmit an indicator to the target cell, for instructing the target cell to feedback the indicator of indicating the assist information is transmitted to the UE, i.e. the assist information is included in the RRC message for instructing the UE to perform a make-before-break based handover to the target cell.

In an embodiment, the timing of the UE stopping communicating with the source cell while performing the make-before-break based handover (e.g. the time T2 or T3 shown in FIG. 8) may be determined based on data radio bearer (DRB). For example, a packet data convergence protocol (PDCP) configuration of at least one DRB may be switched individually. This embodiment is further illustrated in the followings.

Before the make-before-break based handover, each DRB is associated with an independent PDCP entity with a PDCP of the source cell (hereinafter, source PDCP configuration). When the UE receives a RRC message instructing the UE to perform the make-before-break based handover to a target cell from the source cell (e.g. the source cell and the target cell shown in FIG. 8), the UE configures each PDCP entity with the corresponding PDCP configuration received in the RRC message. For example, the UE generates access stratum (AS) keys associated with the target cell (i.e. target AS keys), configures the target AS keys to each PDCP entity and generates robust header compression (ROHC) context associated with the target cell (i.e. target ROHC context) to each PDCP entity. That is, the UE configures a PDCP configuration of the target cell (hereinafter, target PDCP configuration) to each PDCP entity. Note that, the PDCP configuration of the PDCP entity associated to each of the at least one DRB may not switch from the source PDCP configuration to the target PDCP configuration immediately after the target PDCP configuration is configured to each PDCP entity.

In an embodiment, the PDCP configuration of the PDCP entity associated to each of the at least one DRB is switched to the target PDCP configuration based on an operation mode of each of the at least one DRB.

In an example of the operation mode of the DRB being an acknowledged mode (AM), the PDCP configuration of the PDCP entity of this DRB is switched from the source PDCP configuration to the target PDCP configuration when a PDCP status packet data unit (PDU) is generated or transmitted to the target cell. In other words, the UE stops using the source PDCP configuration and starts using the target PDCP configuration when PDCP status packet data unit (PDU) is generated or transmitted to the target cell. Under such a condition, the UE may discard a PDCP PDU if this PDCP PDU is received, from the source cell, for the DRB whose PDCP entity's PDCP configuration is switched the source PDCP configuration to the target PDCP configuration.

In an example of the operation mode of the DRB being an unacknowledged mode (UM), the PDCP configuration of the PDCP entity of this DRB is switched from the source PDCP configuration to the target PDCP configuration when the UE successfully completes the random access procedure on the target cell (e.g. accesses the target cell). After the PDCP configuration of the PDCP entity associated to the DRB is switched from the source PDCP configuration to the target PDCP configuration, the UE may discard a PDCP PDU if this PDCP PDU is received, from the source cell, for this DRB.

In an example, the UE is configured with 3 DRBs DRB-x, DRB-y and DRB-z, wherein operation mode of the DRBs DRB-x and DRB-z are configured as the AM and an operation mode of the DRB DRB-y is configured as UM. With the reception of a RRC message instructing the UE to handover from the source cell to the target cell, the UE configures the three PDCP entities corresponding to the DRBs DRB-x, DRB-y and DRB-z with the corresponding PDCP configuration (configured for the target cell) received in the RRC message (i.e. target PDCP configuration). Note that, the UE keeps using the PDCP configuration configured for source cell (i.e. source PDCP configuration). For example, each of the target PDCP configuration and the source PDCP configuration for reception has configurations at least for header decompression, integrity verification, or deciphering.

For the PDCP entity of the DRB DRB-x (respectively the DRB DRB-z), the UE switches from the source PDCP configuration to the target PDCP configuration once the PDCP status PDU is generated or transmitted to the target cell. That is, when the PDCP status PDU is generated or transmitted, the UE switches to use the target PDCP configuration, i.e. the UE stops using the source PDCP configuration and starts using the target PDCP configuration. If the UE receives DL PDCP PDU for the DRB DRB-x (respectively DRB DRB-z) from the source cell after switching the PDCP configuration of the DRB DRB-x (respectively DRB DRB-z) from the source PDCP configuration to the target PDCP configuration, the UE discards the DL PDCP PDU received from the source cell.

For the PDCP entity of the DRB DRB y, the UE switches from the source PDCP configuration to the target PDCP configuration once the UE successfully completes the random access procedure on the target cell. That is, when the UE successfully completes the random access procedure on the target cell, the UE switches to use the target PDCP configuration, i.e. the UE stops using the source PDCP configuration and starts using the target PDCP configuration. If the UE receives DL PDCP PDU for the DRB DRB-y from the source cell after switching the PDCP configuration of DRB-y from the source PDCP configuration to the target PDCP configuration, the UE discards the DL PDCP PDU received from the source cell.

After the PDCP configuration of the PDCP entity associated with all of the at least one DRB is switched from the source PDCP configuration to the target PDCP configuration, the UE stops transmissions on the source cell (i.e. stop communicating with the source cell). For example, the UE may stop UL transmission and/or DL reception, wherein the UL transmission may be PUSCH transmission and the DL reception may be PDSCH reception.

In this embodiment, the PDCP configuration switching and the switching of the lower layer (e.g. Physical layer) are separated. That is, the PDCP configuration switching is handled on DRB based and the switching of the lower layer (i.e. the stopping transmission on the source cell) is carried out only after the PDCP configuration for all of the at least on DRB has been switched to the target PDCP configuration. Under such a condition, the PDCP configuration switching of one DRB would not impact on the PDCP PDU handling of another DRB. The interruption reduction can be controlled in the granularity of DRB.

In the make-before-break based handover, the UE keeps transmission (DL reception and/or UL transmission) with the source cell and target cell for a certain period of time. However, for some single uplink transmission capable UE, the UE may be capable to perform only one single UL transmission at a time (either to the source cell or to the target cell), e.g., due to power restriction or radio equipment restriction of the UE. Or, for some deployment scenarios (e.g. the source cell and target cell are deployed on the same frequency), the simultaneous transmitting to the source cell and target cell may cause severe interference. Under such conditions, the network (e.g. the target cell) may configure time domain patterns to corporate the UL transmission on the source cell and target cell.

In an embodiment, two time domain patterns TDP1 and TDP2 are configured by the target cell in the RRC message that instructs the UE to perform a make-before-break based handover from the source cell to the target cell, wherein one of time domain patterns TDP1 and TDP2 is configured for the source cell and the another one of the time domain patterns TDP1 and TDP2 is configured for the target cell. For example, the target cell may include time domain pattern configuration information in the RRC message that instructs the UE to perform the make-before-break based handover and the UE is able to determine the time domain patterns TDP1 and TDP2 based on the time domain pattern configuration information. The UE applies the time domain patterns TDP1 and TDP2 to communicate with the source cell and the target cell, separately, until stopping (or releasing) transmissions on the source cell. For example, the UE is not expected to transmit a UL physical channel or signal in the source cell on subframes other than UL subframes indicated in the time domain pattern configured for the source cell. Similarly, the UE is not expected to transmit a UL physical channel or signal in the target cell on subframes other than the UL subframes indicated in the time domain pattern configured for the target cell.

In an example, the target cell may configure a reference UL-DL configuration and an offset value in the time domain pattern configuration information transmitted to the UE, to indicate the time domain patterns TDP1 and TDP2.

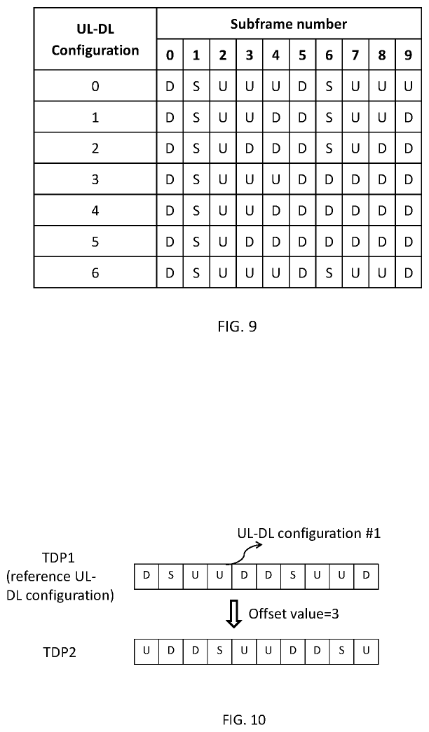

FIG. 9 shows a table of UL-DL configurations according to an embodiment of the present disclosure. The target cell may configure the reference UL-DL configuration to the UE by indicating an index of the UL-DL configuration shown in FIG. 9. The UE may acquire the reference UL-DL configuration as the time domain pattern TDP1 and determine the time domain pattern TDP2 based on the reference UL-DL configuration and the offset value (e.g. shifting subframes in the reference UL-DL configuration by the offset value), or vice versa.

FIG. 10 shows a method of determining the time domain patterns TDP1 and TDP2 according to an embodiment of the present disclosure. In this embodiment, the target cell configures the UL-DL configuration #1 (i.e. the UL-DL configuration with the index 1 shown in FIG. 9) as the reference time domain pattern and sets the offset value to 3. As shown in FIG. 10, the reference time domain pattern (i.e. UL-DL configuration #1) is set as the time domain pattern TDP1 and the time domain pattern TDP2 is acquired by shifting subframes in the reference time domain pattern by the offset value (i.e. shifting 3 subframes).

In an example, the target cell may configure a first reference UL-DL configuration, a second reference UL-DL configuration, a first offset value and a second offset value to the UE, to indicate the time domain patterns TDP1 and TDP2. The UE may determine the time domain pattern TDP1 based on the first reference UL-DL configuration and the first offset value and the time domain pattern TDP2 is determined based on the second reference UL-DL configuration and the second offset value.

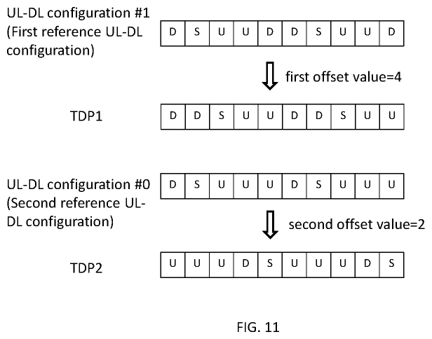

FIG. 11 shows a method of determining the time domain patterns TDP1 and TDP2 according to an embodiment of the present disclosure. In this embodiment, the UL-DL configuration #1 is configured as the first reference UL-DL configuration, the UL-DL configuration #0 is configured as the second reference UL-DL configuration, the first offset value is 4 and the second offset value is 2. As shown in FIG. 11, the time domain pattern TDP1 is acquired by shifting the subframes in the first UL-DL configuration by the first offset value and the time domain pattern TDP2 is acquired by shifting the subframes in the second UL-DL configuration by the second offset value.

In an embodiment, the target cell may also transfer a coordination information to the source cell, to indicate the time domain pattern configured for the transmission between the UE and the source cell. The source cell may use the coordination information for coordinating resources with the target cell. For example, the target cell may transfer the coordination information indicating the UL-DL configuration #2 shown in FIG. 10 to the source cell when the UL-DL configuration #2 is configured to the UE for the transmissions between the UE and the source cell.

In an example, the target cell may transfer the coordination information indicating time domain pattern configuration information for determining the time domain pattern configured for the transmission between the UE and the source cell. For example, if the time domain pattern TDP2 shown in FIG. 10 is configured for the transmission between the UE and the source cell, the target cell may transfer the coordination information indicating the UL-DL configuration #1 and the offset value 3 to the source cell.

In an example, the coordination information may comprise a bit string indicating radio resources in at least one uplink sub-frame configured for the source cell. For example, the bit string may indicate whether a specific frequency and time resource is intended to be used by the source cell or not (i.e. whether each PRB (Physical Radio Block) pair in an uplink subframe is intended to be used by the source cell or not). For example, the bit string spans across N UL subframes and with a length of N*M bits, where M is the number of PRBs in single UL subframe. Each bit in the bit string is corresponding to a PRB (Physical Radio Block) pair in an UL subframe and the value (1 or 0) of each bit indicates whether the corresponding PRB resource is intended to be used by the source cell. The bit string spans from the first PRB pair of the first UL subframe to the last PRB pair of the first UL subframe and from the first PRB pair of the second UL subframe to the last PRB pair of the second UL subframe, and so on.

In an example, the N UL subframes can be N contiguous UL subframes for a FDD network. Or, the N UL subframes can be the N UL subframes in the uplink-downlink configuration which is transferred by the source cell to the target cell.

In an example, the N uplink subframes are the N uplink subframes in the time domain pattern configured for the source cell.

In an example, the N uplink subframes are the N uplink subframes derived based on the time domain pattern configuration information.

1. A wireless communication method for use in a user equipment, comprising:
receiving, from a source cell, at least one first message comprising configuration information and at least one execution condition of performing a handover for each of at least one target cell,
receiving, from the source cell, a second message indicating one of the at least one target cell, and
performing a handover to the target cell indicated by the second message based on the configuration information.

2. The wireless communication method of claim 1, wherein the at least one first message includes identification information of each of the at least one target cell and the second message includes the identification information of the target cell indicated by the second message, and/or
wherein the at least one first message and the second message are radio resource control messages.

3. A wireless communication method for use in a user equipment, comprising:
performing a handover from a source cell to a target cell in response to reception of a message including time domain pattern configuration information,
acquiring a first time domain pattern and a second time domain pattern based on the time domain pattern configuration information, and
communicating with the source cell based on the first time domain pattern and with the target cell based on the second time domain pattern.

4. The wireless communication method of claim 3,
wherein the time domain pattern configuration information comprises a reference uplink/downlink configuration and an offset value, and wherein one of the first time domain pattern and the second time domain pattern is determined based on the reference uplink/downlink configuration and another one of the first time domain pattern and the second time domain pattern is determined based on the reference uplink/downlink configuration and the offset value, or
wherein the time domain pattern configuration information comprises a first reference uplink/downlink configuration, a second reference uplink/downlink configuration, a first offset value and a second offset value, and wherein the first time domain pattern is determined based on the first reference uplink/downlink configuration and the first offset value and the second time domain pattern is determined based on the second reference uplink/downlink configuration and the second offset value.

5. A wireless communication method for use in a target network node, comprising:
transmitting, to a user equipment, a message including time domain pattern configuration information for instructing the user equipment to perform a handover from a source network node to the target network node, for determining a first time domain pattern and a second time domain pattern by the user equipment and for communicating of the user equipment with the source network node based the first time domain pattern and with the target network node based on the second time domain pattern.

6. The wireless communication method of claim 5,
wherein the time domain pattern configuration information comprises a reference uplink/downlink configuration and an offset value, and wherein one of the first time domain pattern and the second time domain pattern is determined based on the reference uplink/downlink configuration and another one of the first time domain pattern and the second time domain pattern is determined based on the reference uplink/downlink configuration and the offset value, or
wherein the time domain pattern configuration information comprises a first reference uplink/downlink configuration, a second reference uplink/downlink configuration, a first offset value and a second offset value, and wherein the first time domain pattern is determined based on the first reference uplink/downlink configuration and the first offset value and the second time domain pattern is determined based on the second reference uplink/downlink configuration and the second offset value.

7. The wireless communication method of claim 5, further comprising:
transmitting, to the source network node, coordination information indicating the first time domain pattern.

8. The wireless communication method of claim 7, wherein:
the coordination information comprises time domain pattern configuration information for determining the first time domain pattern.

9. The wireless communication method of claim 7, wherein the coordination information comprises a bit string indicating radio resources in at least one uplink sub-frame configured for the source network node.

10. The wireless communication method of claim 9, wherein:
the at least one uplink sub-frame is the uplink sub-frame transmitted from the source network node to the target network node, or
the at least one uplink sub-frame is the uplink sub-frame in the first time domain pattern, or
the at least one uplink sub-frame is determined based on the time domain pattern configuration information.

11. A network device comprising:
a processor configured to:
receive, via a receiver from a source cell, at least one first message comprising configuration information and at least one execution condition of performing a handover for each of at least one target cell and a second message indicating one of the at least one target cell; and
perform a handover to the target cell indicated by the second message based on the configuration information.

12. The network device according to claim 11,
wherein the at least one first message includes identification information of each of the at least one target cell and the second message includes the identification information of the target cell indicated by the second message, and/or
wherein the at least one first message and the second message are radio resource control messages.

13. A network device comprising:
a processor, configured to:
perform a handover from a source cell to a target cell in response to reception of a message including time domain pattern configuration information, acquire a first time domain pattern and a second time domain pattern based on the time domain pattern configuration information, and
communicate via a transmitter with the source cell based on the first time domain pattern and with the target cell based on the second time domain pattern.

14. The network device according to claim 13,
wherein the time domain pattern configuration information comprises a reference uplink/downlink configuration and an offset value, and wherein one of the first time domain pattern and the second time domain pattern is determined based on the reference uplink/downlink configuration and another one of the first time domain pattern and the second time domain pattern is determined based on the reference uplink/downlink configuration and the offset value, or
wherein the time domain pattern configuration information comprises a first reference uplink/downlink configuration, a second reference uplink/downlink configuration, a first offset value and a second offset value, and wherein the first time domain pattern is determined based on the first reference uplink/downlink configuration and the first offset value and the second time domain pattern is determined based on the second reference uplink/downlink configuration and the second offset value.

15. A network node comprising:
a processor configured to transmit, via a transmitter to a user equipment, a message including time domain pattern configuration information for instructing the user equipment to perform a handover from a source network node to the target network node, for determining a first time domain pattern and a second time domain pattern by the user equipment and for communicating of the user equipment with the source network node based the first time domain pattern and with the target network node based on the second time domain pattern.

16. The network node according to claim 15,
wherein the time domain pattern configuration information comprises a reference uplink/downlink configuration and an offset value, and wherein one of the first time domain pattern and the second time domain pattern is determined based on the reference uplink/downlink configuration and another one of the first time domain pattern and the second time domain pattern is determined based on the reference uplink/downlink configuration and the offset value, or
wherein the time domain pattern configuration information comprises a first reference uplink/downlink configuration, a second reference uplink/downlink configuration, a first offset value and a second offset value, and wherein the first time domain pattern is determined based on the first reference uplink/downlink configuration and the first offset value and the second time domain pattern is determined based on the second reference uplink/downlink configuration and the second offset value.

17. The network node according to claim 15, wherein the processor is further configured to transmit, via the transmitter to the source network node, coordination information indicating the first time domain pattern.

18. The network node according to claim 17, wherein:
the coordination information comprises time domain pattern configuration information for determining the first time domain pattern.

19. The network node according to claim 17, wherein the coordination information comprises a bit string indicating radio resources in at least one uplink sub-frame configured for the source network node.

20. The network node according to claim 19, wherein:
the at least one uplink sub-frame is the uplink sub-frame transmitted from the source network node to the target network node, or
the at least one uplink sub-frame is the uplink sub-frame in the first time domain pattern, or
the at least one uplink sub-frame is determined based on the time domain pattern configuration information.
